(19) United States
(12) Patent Application Publication
(10) Pub. No.: US 2024/0123959 A1
(43) Pub. Date: Apr. 18, 2024

(54) PRE-FILLED BRAKE APPLY MODULE AND AUTOMATED BLEEDING

(71) Applicant: GM Global Technology Operations LLC, Detroit, MI (US)

(72) Inventors: Jordan SYROWIK, Grand Blanc, MI (US); David B. ANTANAITIS, Northville, MI (US); Brian W. QUINN, Macomb Twp, MI (US)

(21) Appl. No.: 17/968,069

(22) Filed: Oct. 18, 2022

(51) Int. Cl. B60T 11/30

(52) U.S. Cl. CPC B60T 11/30

(57) ABSTRACT

A brake bleeding system includes: a brake apply module of a wheel of a vehicle, the brake apply module including: a brake fluid reservoir; a caliper; and a pump configured to pump brake fluid from the brake fluid reservoir to the caliper; and a bleed screw; and a brake bleed module configured to, in response to user input indicative of a request to bleed air from the brake apply module, operate the pump and bleed air from the brake apply module.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle brakes and more particularly to systems and methods for bleeding brake apply modules of vehicles.

Vehicles include one or more torque producing devices, such as an internal combustion engine and/or one or more electric motors. The torque producing device(s) output torque to one or more wheels of the vehicle. A transmission may be included that transfers torque from a torque producing device to one or more wheels of the vehicle.

Mechanical friction brakes are applied to slow a vehicle. More specifically, a caliper may be included with each wheel of a vehicle. A caliper presses brake pads against a rotor of a wheel to slow rotation of that wheel of the vehicle. The caliper presses the brake pads against the rotor when brake (hydraulic) fluid is applied to the caliper.

### SUMMARY

In a feature, a brake bleeding system includes: a brake apply module of a wheel of a vehicle, the brake apply module including: a brake fluid reservoir; a caliper; and a pump configured to pump brake fluid from the brake fluid reservoir to the caliper; and a bleed screw; and a brake bleed module configured to, in response to user input indicative of a request to bleed air from the brake apply module, operate the pump and bleed air from the brake apply module.

In further features, the brake apply module further includes: a first conduit fluidly connected between the brake fluid reservoir and the pump; and a second conduit fluidly connected between the pump and the caliper.

In further features, the brake bleed module is configured to, before operating the pump, output an indicator to open the bleed screw.

In further features, the brake bleed module is configured to output the indicator visually on a display.

In further features, a brake bleed device includes: the brake bleed module; and the display.

In further features, an input/output port is included where the brake bleed device is connected to the input/output port by wire.

In further features, an infotainment module of the vehicle includes: the brake bleed module; and the display.

In further features, the brake bleed module is configured to output the indicator audibly via a speaker.

In further features, a brake bleed device includes: the brake bleed module; and the speaker.

In further features, an infotainment module of the vehicle includes the brake bleed module, where the infotainment module is configured to output the indicator via the speaker of the vehicle.

In further features, the brake bleed module is configured to operate the pump at a predetermined speed.

In further features, the brake bleed module is configured to operate the pump at the predetermined speed for a predetermined period.

In further features, the brake bleed module is configured to, after operating the pump, output an indicator to close the bleed screw.

In further features, the brake bleed module is configured to output the indicator visibly via a display.

In further features, the brake bleed module is configured to output the indicator audibly via a speaker.

In further features: a second brake apply module of a second wheel of the vehicle is included and includes: a second brake fluid reservoir; a second caliper; and a second pump configured to pump brake fluid from the second brake fluid reservoir to the second caliper; and a second bleed screw, where the brake bleed module is further configured to operate the second pump and bleed air from the second brake apply module.

In further features, the brake bleed module is configured to operate the second pump and bleed air from the second brake apply module after operating the pump and bleeding air from the brake apply module.

In further features, the brake bleed module is configured to operate the second pump and bleed air from the second brake apply module concurrently with operating the pump and bleeding air from the brake apply module.

In further features, the brake apply module is filled with brake fluid before the brake apply module is added to the vehicle.

In a feature, a brake bleeding method includes: receiving user input indicative of a request to bleed air from a brake apply module of a wheel of a vehicle, the brake bleed module including: a brake fluid reservoir; a caliper; and a pump configured to pump brake fluid from the brake fluid reservoir to the caliper; and a bleed screw; and in response to the user input indicative of the request to bleed air from the brake apply module of the wheel of the vehicle, operating the pump and bleeding air from the brake apply module.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example vehicle system;

FIG. 2 is a functional block diagram of an example brake system of a vehicle;

FIG. 3 is a functional block diagram of an example implementation of a brake apply module of a wheel; and

FIG. 4 is a flowchart depicting an example method of bleeding air from a brake apply module.

In the drawings, reference numbers may be reused to identify similar and/or identical elements.

### DETAILED DESCRIPTION

Brake apply modules of a vehicle include a reservoir to store brake fluid, a brake fluid pump, a caliper, and hoses that connect the brake fluid reservoir to the brake fluid pump and the brake fluid pump to the caliper. One brake apply module may be provided with each wheel of the vehicle. This is different than a braking system with one brake fluid reservoir and one actuator that provides brake fluid to the calipers of all wheels of the vehicle.

Brake apply modules may be manufactured by suppliers and sent to vehicle manufacturers not filled with brake fluid. Vehicle manufacturers can assemble brake apply modules into vehicles, fill the brake apply modules with brake fluid, and bleed air from the brake apply modules during vehicle assembly. This, however, takes up a relatively large amount of space, is time consuming, and slows vehicle manufacturing.

The present application involves brake apply modules that are provided by suppliers to vehicle manufacturers already filled with brake fluid. A brake bleed module is used to perform an automated process of bleeding air from the brake apply modules. This minimizes space within vehicle manufacturing plants, decreases time necessary for vehicle assembly, and increases vehicle manufacturing throughput.

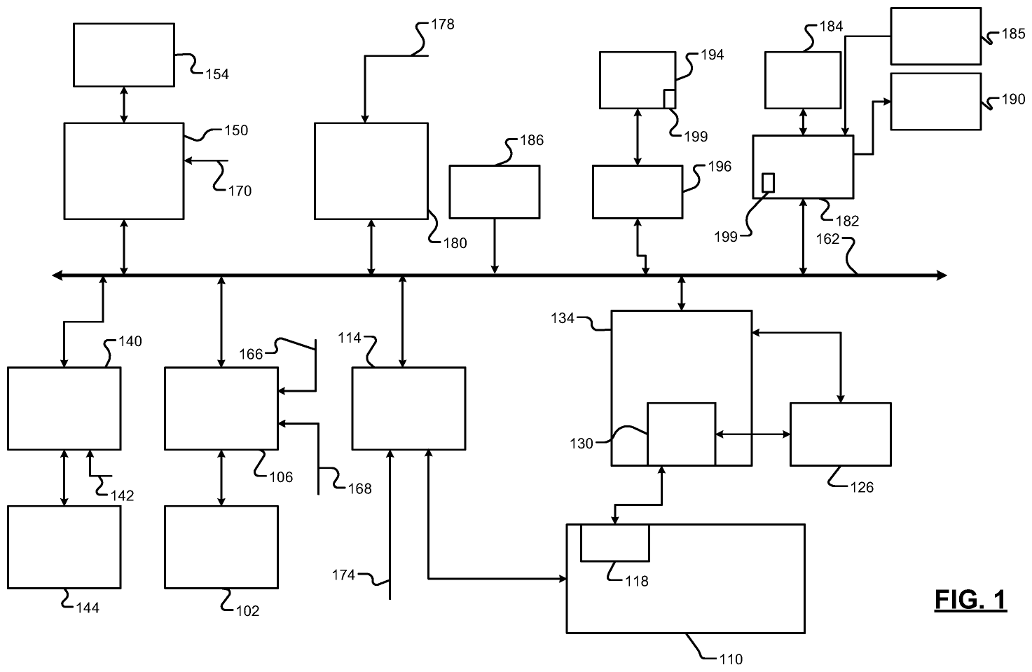

Referring now to FIG. 1, a functional block diagram of an example vehicle system is presented. While a vehicle system for a hybrid vehicle is shown and will be described, the present disclosure is also applicable to non-hybrid vehicles, electric vehicles, fuel cell vehicles, and other types of vehicles. The present application is applicable to autonomous vehicles, non-autonomous vehicles, semi-autonomous vehicles, and other types of vehicles.

An engine 102 may combust an air/fuel mixture to generate drive torque. An engine control module (ECM) 106 controls the engine 102 based on one or more driver inputs. For example, the ECM 106 may control actuation of engine actuators, such as a throttle valve, one or more spark plugs, one or more fuel injectors, valve actuators, camshaft phasers, an exhaust gas recirculation (EGR) valve, one or more boost devices, and other suitable engine actuators. In electric vehicles, the engine 102 may be omitted.

The engine 102 may output torque to a transmission 110. A transmission control module (TCM) 114 controls operation of the transmission 110. For example, the TCM 114 may control gear selection within the transmission 110 and one or more torque transfer devices (e.g., a torque converter, one or more clutches, etc.).

The vehicle system may include one or more electric motors. For example, an electric motor 118 may be implemented within the transmission 110 as shown in the example of FIG. 1. An electric motor can act as either a generator or as a motor at a given time. When acting as a generator, an electric motor converts mechanical energy into electrical energy. The electrical energy can be, for example, used to charge a battery 126 via a power control device (PCD) 130. When acting as a motor, an electric motor generates torque that may be used, for example, to supplement or replace torque output by the engine 102. While the example of one electric motor is provided, the vehicle may include zero or more than one electric motor.

A power inverter module (PIM) 134 may control the electric motor 118 and the PCD 130 based on one or more driver inputs. The PCD 130 applies (e.g., direct current) power from the battery 126 to the (e.g., alternating current) electric motor 118 based on signals from the PIM 134, and the PCD 130 provides power output by the electric motor 118, for example, to the battery 126. The PIM 134 may be referred to as an inverter module in various implementations.

A steering control module 140 controls steering/turning of wheels of the vehicle, for example, based on driver turning of a steering wheel within the vehicle and/or steering commands from one or more vehicle control modules. A steering wheel angle sensor (SWA) monitors rotational position of the steering wheel and generates a SWA 142 based on the position of the steering wheel. As an example, the steering control module 140 may control vehicle steering via an EPS motor 144 based on the SWA 142. However, the vehicle may include another type of steering system. An electronic brake control module (EBCM) 150 may selectively apply mechanical (friction) brakes 154 of the vehicle, for example, based on one or more driver inputs.

Some modules of the vehicle may communicate with each other and share parameters via a network 162, such as a controller area network (CAN) or another suitable type of network. A CAN may also be referred to as a car area network. The network 162 may include one or more data buses. Various parameters may be made available by control modules to other control modules via the network 162.

The driver inputs may include, for example, an accelerator pedal position (APP) 166 which may be provided to the ECM 106. A cruise control input 168 may also be input to the ECM 106 from a cruise control system. In various implementations, the cruise control system may include an adaptive cruise control system. A brake pedal position (BPP) 170 may be provided to the EBCM 150. A position 174 of a park, reverse, neutral, drive lever (PRNDL) may be provided to the TCM 114. An ignition state 178 may be provided to a body control module (BCM) 180. For example, the ignition state 178 may be input by a driver via an ignition key, button, or switch. At a given time, the ignition state 178 may be one of off, accessory, run, or crank. While example inputs are provided, the present application is also applicable to other driver inputs. Additionally or alternatively, the modules may utilize one or more other inputs.

The vehicle system may include an infotainment module 182. The infotainment module 182 controls what is displayed on a display 184. The display 184 may be a touchscreen display in various implementations and transmit signals indicative of user input to the display 184 to the infotainment module 182. The infotainment module 182 may additionally or alternatively receive signals indicative of user input from one or more other user input devices 185, such as one or more switches, buttons, knobs, etc. Another type of user input device includes one or more microphones within the passenger cabin.

The infotainment module 182 may receive signals from a plurality of external sensors and cameras, generally illustrated in FIG. 1 by 186. For example, the infotainment module 182 may display video, various views, and/or alerts on the display 184 via input from the external sensors and cameras 186. The external sensors and cameras 186 sense and capture images of the environment around the vehicle.

The infotainment module 182 may also generate output via one or more other devices. For example, the infotainment module 182 may output sound via one or more speakers 190 of the vehicle. The vehicle may include one or more additional control modules that are not shown, such as a chassis control module, a battery pack control module, etc. The vehicle may omit one or more of the modules shown and discussed.

Input from the external sensors and cameras 186 may also be used to control autonomous driving, determining whether to enter into or disable autonomous driving, and/or for one or more other uses.

The vehicle may also include an input/output port 196, such as an on board diagnostic (OBD) port. For example only, the input/output port 196 may be an OBD-2 port. In various implementations, the input/output port 196 may be a 16 pin port or have another suitable number of input/output pins.

Computing devices, such as a brake bleed device 194, may connect to the input/output port 196 by wire. The brake bleed device 194 may be a battery powered mobile device in various implementations. Via the input/output port 196, computing devices can transmit information to the network 162 and receive data of the vehicle from the network 162. For example, (a brake bleed module 199 of) the brake bleed device 194 may control performance of a brake bleeding procedure to bleed air out of hydraulic (brake) fluid lines of brake apply units, as discussed below. In various implementations, the brake bleeding procedure may be performed by (a brake bleed module 199 of) the infotainment module 182. While the example of the brake bleed device 194 connecting to the vehicle by wire is shown, the brake bleed device 194 may alternatively connect to the vehicle wirelessly, such as via a wireless Bluetooth connection.

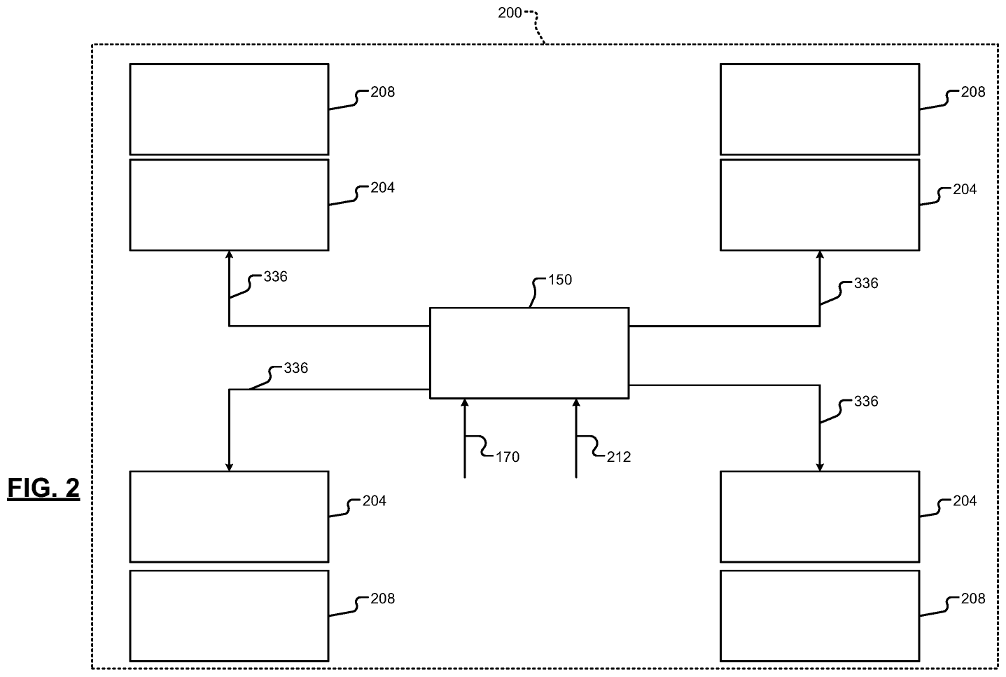

FIG. 2 is a functional block diagram of an example brake system of the vehicle 200 of FIG. 1. The vehicle 200 includes brake apply modules 204 configured to mechanically brake (slow) rotation of wheels 208, respectively, of the vehicle 200. While the example of the vehicle 200 including four wheels 208 and four associated brake apply modules 204, respectively, the present application is also applicable to other numbers of wheels and other numbers of brake apply modules. In various implementations, one brake apply module may be provided for a pair of wheels, such as dual rear wheel vehicles.

The EBCM 150 controls the brake apply modules 204. During vehicle operation, the EBCM 150 may actuate the brake apply modules 204 based on the BPP 170. For example, the EBCM 150 may increase actuation of the brake apply modules 204 (e.g., calipers of the brake apply modules 204) as the BPP 170 increases and vice versa.

The EBCM 150 also controls the brake apply modules 204 for performance of a brake breed process according to a brake bleed signal 212. The brake bleed signal 212 may be generated by the brake bleed module 199, such as of the brake bleed device 194 or the infotainment module 182. The brake bleed signal 212 may be received by the vehicle 200 wirelessly or by wire. The brake bleed process is performed to bleed air from hydraulic lines of the brake apply modules 204 through which fluid flows to calipers of the brake apply modules 204.

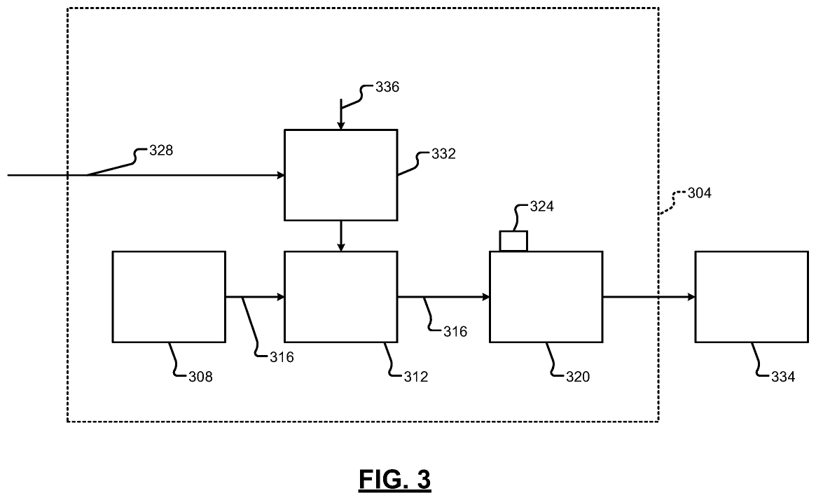

FIG. 3 is a functional block diagram of an example implementation of one of the brake apply modules 204, brake apply module 304. Each of the brake apply modules 204 may be the same as the brake apply module 304.

The brake apply module 304 includes a brake fluid reservoir 308, an electric brake fluid pump 312, hydraulic fluid hoses 316 (conduits), a caliper 320, and a bleed screw or valve 324. Brake fluid is stored in the brake fluid reservoir 308. The brake fluid pump 312 receives power 328 (e.g. from a battery of the vehicle), such as direct current (DC) power. the electric brake fluid pump includes an electric motor, such as a DC motor. When on, the brake fluid pump 312 pumps brake fluid from the brake fluid reservoir 308 to the caliper 320 via the hose(s) 316.

The caliper 320 actuates and presses one or more brake pads 334 against a rotor of the wheel with which the brake apply module 304 is associated when the brake fluid pump 312 pumps brake fluid to the caliper 320. The pressure applied by the caliper 320 increases as the pressure of the brake fluid applied to the caliper 320 increases and vice versa. The brake pad(s) 334 slow rotation of the wheel via friction on the rotor.

The bleed screw 324 can be opened to allow air and/or brake fluid to be removed from brake apply module 304, such as for the brake bleeding process. When the bleed screw 324 is closed, the brake apply module 304 includes a closed hydraulic circuit.

The brake apply module 304 also includes a pump control module 332 that controls the brake fluid pump 312 of the brake apply module 304. The pump control module 332 controls whether the brake fluid pump 312 is on or off and, if on, a speed of the brake fluid pump 312. The pump control module 332 applies power to the brake fluid pump 312 to operate the brake fluid pump 312. The pump control module 332 may increase a power (e.g., voltage or current) to the brake fluid pump 312 to increase the speed of the brake fluid pump 312 and vice versa. The pump control module 332 controls the brake fluid pump 312 based on a commanded speed 336 from the EBCM 150. The pump control module 332 may turn the brake fluid pump 312 off when the commanded speed 336 is set to zero.

The brake apply module 304 (including the brake fluid reservoir 308, the hoses 316, the brake fluid pump 312, and the caliper 320) may be filled with brake fluid by a brake apply module supplier and shipped filled with brake fluid to a vehicle manufacturer.

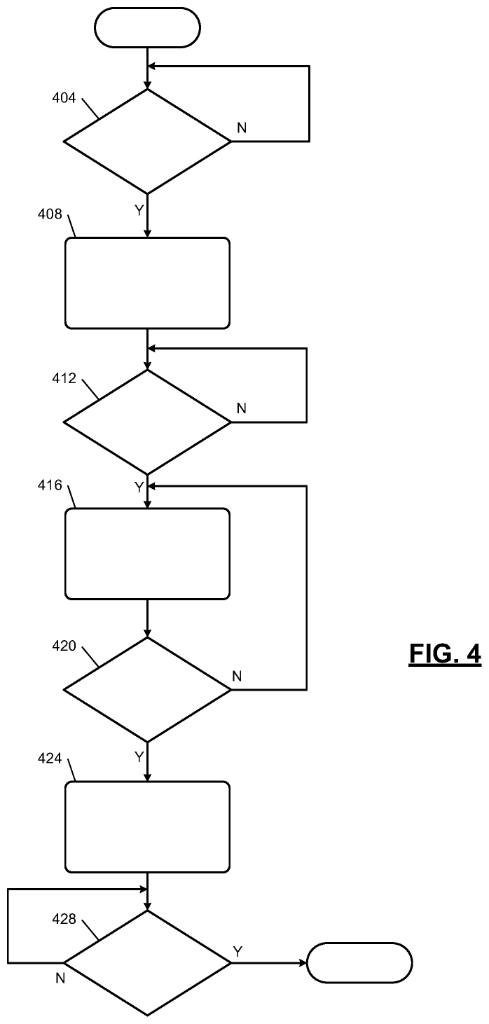

FIG. 4 is a flowchart depicting an example method of bleeding air from the brake apply module 304. While the example of bleeding air from one of the brake apply modules is provided, all of the brake apply modules may be bled of air concurrently. Alternatively, the brake apply modules may be bled of air in a predetermined order (e.g., right front, left front, left rear, right rear or another suitable order) and indicators of which brake apply module to bleed of air may be output.

Control begins with 404 where the brake bleed module 199 determines whether user input has been received indicative of a request to bleed the brake apply module 304 of air. If 404 is true, control continues with 408. If 404 is false, control may remain at 404. The request may be received in response to user actuation of one or more user input devices. Actuation may include touching in the example of a touch screen display.

At 408, the brake bleed module 199 outputs a first indicator to open the bleed screw 324. The first indicator may include a visual indicator and/or an audible indicator. For example, the brake bleed module 199 may output a textual indicator to open the bleed screw 324 on one or more displays or illuminate one or more lights to open the bleed screw 324. Additionally or alternatively, the brake bleed module 199 may output an audible indicator to open the bleed screw 324 via one or more speakers. In various implementations, the brake bleed module 199 may output a haptic indicator via one or more vibrating devices.

At 412, the brake bleed module 199 determines whether user input has been received indicative of a request to continue and/or that the bleed screw 324 is open. If 412 is true, control continues with 416. If 412 is false, control may remain at 412. The request may be received in response to user actuation of one or more user input devices. In various implementations, the brake bleed module 199 may output the first indicator to open the bleed screw 324 multiple times if 412 is not true within a predetermined period.

At 416, the brake bleed module 199 transmits a command to the EBCM 150 to operate the brake fluid pump 312 at a predetermined speed that is greater than zero. The predetermined speed may be, for example, approximately 100 revolutions per minute or another suitable speed. In response, the EBCM 150 transmits the speed command 336 to the pump control module 332 to operate at the predetermined speed, and the pump control module 332 applies power to the brake fluid pump 312 to operate at the predetermined speed. The brake fluid pump 312 then pumps brake fluid from the brake fluid reservoir to the caliper 320. Because the bleed screw 324 is open, air in the hoses 316 can exit through the aperture of the bleed screw 324.

At 420, the brake bleed module 199 determines whether a predetermined period has passed since 416 was first performed. In other words, the brake bleed module 199 determines whether the brake fluid pump 312 has been operated at the predetermined speed for at least the predetermined period with the bleed screw 324 open. If 420 is true, control continues with 424. If 420 is false, control returns to 416 to continue operating the brake fluid pump 312 at the predetermined speed with the bleed screw 324 open. The predetermined period is greater than zero and is set to a period when all air will have been bled from the brake apply module 304. The predetermined period may be, for example, approximately 15 seconds or another suitable speed.

At 424, the brake bleed module 199 turns off the brake fluid pump 312 (via the EBCM 150 and the pump control module 332) and outputs a second indicator to close the bleed screw 324. The second indicator may include a visual indicator and/or an audible indicator. For example, the brake bleed module 199 may output a textual indicator to close the bleed screw 324 on one or more displays or illuminate one or more lights to second the bleed screw 324. Additionally or alternatively, the brake bleed module 199 may output an audible indicator to second the bleed screw 324 via one or more speakers. In various implementations, the brake bleed module 199 may output a haptic indicator via one or more vibrating devices.

At 428, the brake bleed module 199 determines whether user input has been received indicative of a confirmation that closing of the bleed screw 324 is complete. If 428 is true, bleeding of air from within the brake apply module 304 is complete and control may end. If 428 is false, control may remain at 428. The request may be received in response to user actuation of one or more user input devices. In various implementations, the brake bleed module 199 may output the second indicator to close the bleed screw 324 multiple times if 428 is not true within a predetermined period.

In various implementations, the brake bleed module may 199 pause at the present portion of FIG. 4 in response to receipt of user input indicative of a request to pause. The request may be received in response to user actuation of one or more user input devices. Pausing may include turning off the brake fluid pump 312 if the brake fluid pump 312 is on. This may allow a user to pause the brake bleed process at any time during the brake bleed process.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A brake bleeding system comprising:
a brake apply module of a wheel of a vehicle, the brake apply module including:
a brake fluid reservoir;
a caliper; and
a pump configured to pump brake fluid from the brake fluid reservoir to the caliper; and
a bleed screw; and
a brake bleed module configured to, in response to user input indicative of a request to bleed air from the brake apply module, operate the pump and bleed air from the brake apply module.

2. The brake bleeding system of claim 1 wherein the brake apply module further includes:
a first conduit fluidly connected between the brake fluid reservoir and the pump; and
a second conduit fluidly connected between the pump and the caliper.

3. The brake bleeding system of claim 1 wherein the brake bleed module is configured to, before operating the pump, output an indicator to open the bleed screw.

4. The brake bleeding system of claim 3 wherein the brake bleed module is configured to output the indicator visually on a display.

5. The brake bleeding system of claim 4 further comprising a brake bleed device including:
the brake bleed module; and
the display.

6. The brake bleeding system of claim 5 further comprising an input/output port, wherein the brake bleed device is connected to the input/output port by wire.

7. The brake bleeding system of claim 4 further comprising an infotainment module of the vehicle including:
the brake bleed module; and
the display.

8. The brake bleeding system of 3 wherein the brake bleed module is configured to output the indicator audibly via a speaker.

9. The brake bleeding system of claim 8 further comprising a brake bleed device including:
the brake bleed module; and
the speaker.

10. The brake bleeding system of claim 4 further comprising an infotainment module of the vehicle including the brake bleed module, wherein the infotainment module is configured to output the indicator via the speaker of the vehicle.

11. The brake bleeding system of claim 1 wherein the brake bleed module is configured to operate the pump at a predetermined speed.

12. The brake bleeding system of claim 11 wherein the brake bleed module is configured to operate the pump at the predetermined speed for a predetermined period.

13. The brake bleeding system of claim 1 wherein the brake bleed module is configured to, after operating the pump, output an indicator to close the bleed screw.

14. The brake bleeding system of claim 13 wherein the brake bleed module is configured to output the indicator visibly via a display.

15. The brake bleed system of claim 13 wherein the brake bleed module is configured to output the indicator audibly via a speaker.

16. The brake bleeding system of claim 1 further comprising:
a second brake apply module of a second wheel of the vehicle, the second brake apply module including:
a second brake fluid reservoir;
a second caliper; and
a second pump configured to pump brake fluid from the second brake fluid reservoir to the second caliper; and
a second bleed screw,
wherein the brake bleed module is further configured to operate the second pump and bleed air from the second brake apply module.

17. The brake bleeding system of claim 16 wherein the brake bleed module is configured to operate the second pump and bleed air from the second brake apply module after operating the pump and bleeding air from the brake apply module.

18. The brake bleeding system of claim 16 wherein the brake bleed module is configured to operate the second pump and bleed air from the second brake apply module concurrently with operating the pump and bleeding air from the brake apply module.

19. The brake bleeding system of claim 1 wherein the brake apply module is filled with brake fluid before the brake apply module is added to the vehicle.

20. A brake bleeding method comprising:
receiving user input indicative of a request to bleed air from a brake apply module of a wheel of a vehicle, the brake bleed module including:
a brake fluid reservoir;
a caliper; and
a pump configured to pump brake fluid from the brake fluid reservoir to the caliper; and
a bleed screw; and
in response to the user input indicative of the request to bleed air from the brake apply module of the wheel of the vehicle, operating the pump and bleeding air from the brake apply module.
